(19) United States
(12) Patent Application Publication
(10) Pub. No.: US 2012/0294623 A1
(43) Pub. Date: Nov. 22, 2012

(54) OPTICAL TRANSCEIVER MODULE FOR CONTROLLING POWER IN LANE

(75) Inventors: Joon Ki LEE, Daejeon (KR); Sae-Kyoung KANG, Daejeon (KR); Joon Young HUH, Daejeon (KR)

(73) Assignee: Electronics and Telecommunications Research Institute, Daejeon (KR)

(21) Appl. No.: 13/438,706

(22) Filed: Apr. 3, 2012

(30) Foreign Application Priority Data
May 18, 2011 (KR) 10-2011-0046742

(51) Int. Cl. H04B 10/00

(52) U.S. Cl. 398/135

(57) ABSTRACT

Disclosed is an optical transceiver module for controlling power in each lane. The optical transceiver module includes: a plurality of transmitting units formed in each lane in order to transmit signals to receive electric signals in each lane, convert the received electric signals into optical signals, and transmit the converted optical signals, respectively; a first switching means turning on/off power supplied to each of the plurality of transmitting units in each lane; a plurality of receiving units formed in each lane to receive optical signals in each lane, convert the received optical signals into electric signals, and output the converted electric signals, respectively; a second switching means turning on/off power supplied to each of the plurality of receiving units in each lane; and a control means controlling switching operations of the first switching means and the second switching means.

### CROSS-REFERENCE TO RELATED APPLICATIONS

This application claims priority to and the benefit of Korean Patent Application No. 10-2011-0046742 filed in the Korean Intellectual Property Office on MAY 18, 2011, the entire contents of which are incorporated herein by reference.

### TECHNICAL FIELD

The present invention relates to an optical transceiver module, and particularly, to an optical transceiver module for controlling power in each lane capable of controlling power-on/off of a circuit element by a lane unit, in which the power is disposed on the lane for transmitting a data signal in a multi-lane mode.

### BACKGROUND ART

A transceiver module for optical communication (hereinafter, referred to as an optical transceiver module), as a module that performs functions of optical-electric conversion and electric-optical conversion in a system, has performed the functions at a high speed such as 2.5 Gbps level, 10 Gbps level, 40 Gbps level, and the like, in response to the increase of data traffic. In order to transmit large-sized data traffic, standards for 40 G Ethernet and 100G Ethernet were established by the IEEE (Institute of Electrical and Electronics Engineers) standard institute.

In the case of transmitting a 40G Ethernet signal, a method of dividing the 40 G Ethernet signal into four 10 G signals to transmit the four signals in parallel has been standardized and in the case of transmitting a 100 G Ethernet signal, a method of dividing the 100 G Ethernet signal into ten 10 G signals to transmit the ten 10 G signals in parallel or dividing the 100 Ethernet signal into four 25 G signals to transmit the four 25 G signals in parallel has been standardized. A multi-lane method is being applied as the method of transmitting the high-speed data signal.

FIG. 1 is an exemplified diagram illustrating the configuration of an optical transceiver module for 40G Ethernet in the related art.

As shown in FIG. 1, an optical transceiver module for 40 GBASE-LR4 transmitting 10 km through a single mode optical fiber among optical transceiver modules for 40 G Ethernet is shown. In the case of the optical transceiver, when four 10 G electric signals TXLANE 0 to TXLANE 3 are inputted from a system board, the four 10 G electric signals are converted into optical signals through a clock and data recovery (TX CDR), a laser diode (LD) driver, and a transmitter optical sub-assembly (TOSA) and the four optical signals are transmitted to one optical fiber through an optical multiplexer (optical MUX).

In the case of a reverse process, the transmitted optical signals are divided into four optical signals through an optical DMUX and converted into the electric signals in a receiver optical sub-assembly (ROSA), and four 10 G electric signals RXLANE 0 to RXLANE 3 are outputted to the system board through a limiting amplifier and an RX CDR.

As described above, in the case of a multi-lane optical transceiver module in the related art which is mainly used for Ethernet, there is an enable/disable function of the laser diode (LD) in the TOSA, but there is no function capable of controlling power-on/off by each lane unit.

### SUMMARY OF THE INVENTION

The present invention has been made in an effort to provide an optical transceiver module, and particularly, to an optical transceiver module for controlling power in each lane capable of controlling on/off of the power of a circuit element by a lane unit, in which the power is disposed on the lane for transmitting a data signal in a multi-lane mode.

However, the effort of the present invention is not limited to the aforementioned description and other efforts which are not mentioned above will be apparent to those skilled in the art from the disclosure to be described below.

An exemplary embodiment of the present invention provides an optical transceiver module, including: a plurality of transmitting units formed in each lane in order to transmit signals to receive electric signals in each lane, convert the received electric signals into optical signals, and transmit the converted optical signals, respectively; a first switching means turning on/off power supplied to each of the plurality of transmitting units in each lane; a plurality of receiving units formed in each lane to receive optical signals in each lane, convert the received optical signals into electric signals, and output the converted electric signals, respectively; a second switching means turning on/off power supplied to each of the plurality of receiving units in each lane; and a control means controlling switching operations of the first switching means and the second switching means.

The transmitting unit may include: a clock and data recovery (TX CDR) correcting distortion of the received electric signal; a laser diode (LD) driver amplifying the corrected electric signal; and a transmitter optical sub-assembly (TOSA) converting the amplified electric signal into the optical signal, wherein the TX CDR, the LD driver, and the TOSA are turned on/off at the same time or in sequence.

The first switching means may be provided as many as the number of the plurality of transmitting units to be connected to each of the plurality of transmitting units.

The first switching means may be provided as many as the number of the TX CDRs, the LD drivers, and the TOSAs to be connected to each of the TX CDRs, the LD drivers, and the TOSAs.

The receiving unit may include: a receiver optical sub-assembly (ROSA) converting the received optical signal to an electric signal; a limiting amplifier amplifying the converted electric signal; and a clock and data recovery (RX CDR) correcting distortion of the amplified electric signal, wherein the RX CDR, the limiting amplifier, and the ROSA are turned on/off at the same time or in sequence.

The second switching means may be provided as many as the number of the plurality of receiving units to be connected to each of the plurality of receiving units.

The second switching means may be provided as many as the number of the RX CDRs, the limiting amplifiers, and the ROSAs to be connected to each of the RX CDRs, the limiting amplifiers, and the ROSAs.

Each of the first switching means and the second switching means may be a power switch or a load switch.

The control means may receive a control signal including enable/disable information in each lane from a system board to control a switching operation of the first switching means or the second switching means according to the received control signal.

The control means may receive the control signal including the enable/disable information in each lane from the system board through a management data input/output (MDIO) or inter integrated circuit (I2C) interface.

The control means may control the operations of the first switching means and the second switching means through a serial peripheral interface (SPI), an inter integrated circuit (I2C) interface, or voltage application.

Another exemplary embodiment of the present invention provides an optical transceiver module for controlling power in each lane, including: a plurality of transmitting units formed in each lane in order to transmit signals to receive electric signals in each lane, convert the received electric signals into optical signals, and transmit the converted optical signals, respectively; a first switching means turning on/off power supplied to each of the plurality of transmitting units in each lane; and a control means controlling a switching operation of the first switching means.

The transmitting unit may include: a clock and data recovery (TX CDR) correcting distortion of the received electric signal; a laser diode (LD) driver amplifying the corrected electric signal; and a transmitter optical sub-assembly (TOSA) converting the amplified electric signal into the optical signal, wherein the TX CDR, the LD driver, and the TOSA are turned on/off at the same time or in sequence.

In the transmitting unit, the TX CDR, the LD driver, and the TOSA may be implemented in one chip to be turned on/off at the same time or in sequence.

Yet another exemplary embodiment of the present invention provides an optical transceiver module for controlling power in each lane, including: a plurality of receiving units formed in each lane in order to transmit a signal to receive optical signals in each lane, convert the received optical signals into electric signals, and output the converted electric signals, respectively; a second switching means turning on/off power supplied to each of the plurality of receiving units in each lane; and a control means controlling switching operations of the first switching means and the second switching means.

The receiving unit may include: a receiver optical sub-assembly (ROSA) converting the received optical signal to an electric signal; a limiting amplifier amplifying the converted electric signal; and a clock and data recovery (RX CDR) correcting distortion of the amplified electric signal, wherein the RX CDR, the limiting amplifier, and the ROSA are turned on/off at the same time or in sequence.

In the receiving unit, the RX CDR, the limiting amplifier, and the ROSA are implemented in one chip to be turned on/off at the same time or in sequence.

According to the exemplary embodiments of the present invention, it is possible to largely reduce power consumption in a system or a network by controlling power-on/off of a circuit element by a lane unit, in which the power is disposed on the lane transmitting a data signal in a multi-lane mode.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exemplified diagram illustrating the configuration of an optical transceiver module for 40G Ethernet in the related art.

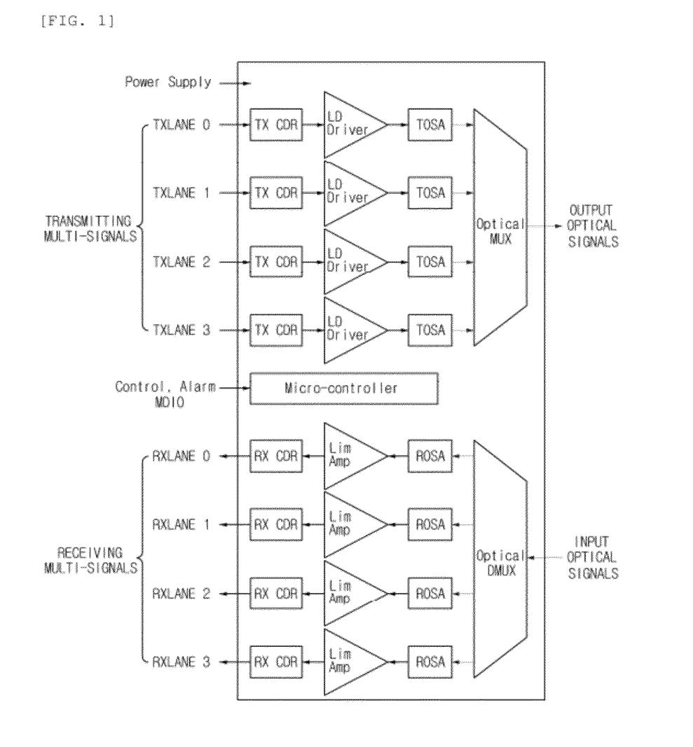

FIG. 2 is a first exemplified diagram illustrating the configuration of an optical transceiver module according to an exemplary embodiment of the present invention.

FIG. 3 is a second exemplified diagram illustrating the configuration of an optical transceiver module according to an exemplary embodiment of the present invention.

FIG. 4 is a third exemplified diagram illustrating the configuration of an optical transceiver module according to an exemplary embodiment of the present invention.

FIG. 5 is an exemplified diagram for describing a principle interlocked with a system board according to an exemplary embodiment of the present invention.

FIG. 6 is an exemplified diagram illustrating a predetermined register map according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

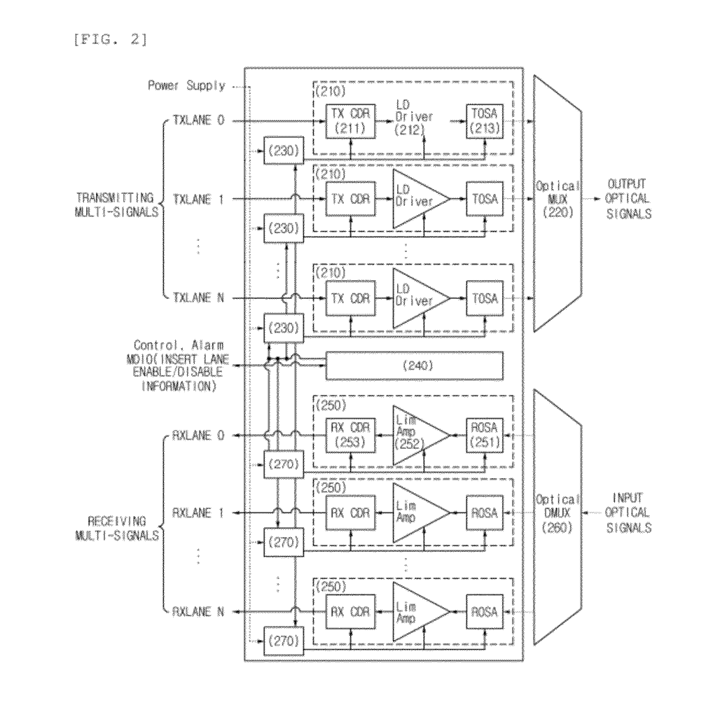

Hereinafter, an optical transceiver module for controlling power in each lane according to an exemplary embodiment of the present invention will be described with reference to FIGS. 2 to 6. Necessary parts for understanding operations and effects according to the present invention will be mainly described in detail. Like reference numerals presented in each drawing designate like elements throughout the specification.

In the present invention, measures capable of controlling power-on/off of a circuit element disposed on a lane transmitting a data signal in a multi-lane mode by a lane unit are proposed.

That is, when the present invention has a function capable of turning on/off power of the circuit element on each lane by a lane unit, the present invention may have a great advantage as compared with just turning on/off power of an LD from the viewpoint of power consumption. For example, in the case where about 10 G is just transmitted because capacity of data traffic is small in a system, only one lane is operated on the optical transceiver module and all of other lanes are turned off, thereby largely reducing the power consumption.

FIG. 2 is an exemplified diagram illustrating the configuration of an optical transceiver module according to an exemplary embodiment of the present invention.

As shown in FIG. 2, the optical transceiver module according to the exemplary embodiment of the present invention is mounted on a system board and may include a plurality of transmitting units 210, an optical MUX 220, a first switching means 230, a control means 240, a plurality of receiving units 250, an optical DMUX 260, a second switching means 270, and the like.

The transmitting units 210 are formed in each lane for transmitting signals to receive electric signals in each lane, convert the received electric signals into optical signals, and output the converted optical signals, respectively. Herein, in the transmitting units 210, power may be independently transferred in each lane.

The transmitting unit 210 may include a clock and data recovery (TX CDR) 211, a laser diode (LD) driver 212, a transmitter optical sub-assembly (TOSA) 213, and the like.

The TX CDR 211 may correct distortion of the received electric signal. That is, since a high-speed signal is inputted from the system board through a printed circuit board (PCB) or a connector and thus the signal may be deformed, the TX CDR 211 corrects the distortion of the signal.

The LD driver 212 may amplify the corrected electric signal. That is, since the form of the inputted signal and the intensity thereof may weaken, the LD driver 212 amplifies the signal. Further, the LD driver 212 may also enable/disable the LD in the TOSA 213.

The TOSA 213 may convert the amplified electric signal into the optical signal and output the converted optical signal.

The optical MUX 220 may multiplex a plurality of optical signals outputted from each of the plurality of transmitting units 210 through the process to transmit the multiplexed optical signals through one optical fiber.

In this case, the control means 240 may turn on/off the power supplied to each of the plurality of transmitting units 210 through the first switching means 230 in each lane. That is, the control means 240 turns on/off the TX CDR 211, the LD driver 212, and the TOSA 213 included in one transmitting unit at the same time. For example, the control means 240 may turn on/off the power which is applied to each of the TX CDR 211, the LD driver 212, and the TOSA 213 included in one transmitting unit at the same time or in sequence.

To this end, the first switching means 230 is provided as many as the plurality of transmitting units to be connected to each of the plurality of transmitting units.

The optical DMUX 260 may demultiplex the plurality of optical signals received through the optical fiber to output the demultiplexed optical signals to the plurality of receiving units 250.

The receiving units 250 are formed in each lane in order to receive signals to receive optical signals in each lane, convert the received optical signals into electric signals, and output the converted electric signals, respectively. Herein, in the receiving units 250, the power may be independently transferred in each lane. The receiving unit 250 may include a receiver optical sub-assembly (ROSA) 251, a limiting amplifier 252, a clock and data recovery (RX CDR) 253, and the like.

The ROSA 251 may convert the received optical signal into the electric signal and output the converted electric signal.

The limiting amplifier 252 may amplify the converted electric signal. That is, the limiting amplifier 252 amplifies the signal because the intensity of the received signal may weaken.

The RX CDR 253 may correct distortion of the amplified electric signal and output the corrected electric signal.

In this case, the control means 240 may turn on/off the power supplied to each of the plurality of receiving units 250 through the second switching means 270 in each lane. That is, the control means 240 turns on/off the ROSA 251, the limiting amplifier 252, and the RX CDR 253 included in one transmitting unit at the same time. For example, the control means 240 may turn on/off the power which is applied to each of the ROSA 251, the limiting amplifier 252, and the RX CDR 253 included in one transmitting unit at the same time or in sequence.

To this end, the second switching means 270 is provided as many as the plurality of receiving units to be connected to each of the plurality of receiving units.

The control means 240 may control the first switching means 230 and the second switching means 270 through a serial peripheral interface (SPI), an I2C interface, or voltage application.

In this case, the TX CDR 211, the LD driver 212, and the TOSA 213 constituting the transmitting unit 210 may be implemented by being physically separated from each other and may also be implemented by being physically coupled with each other in one chip.

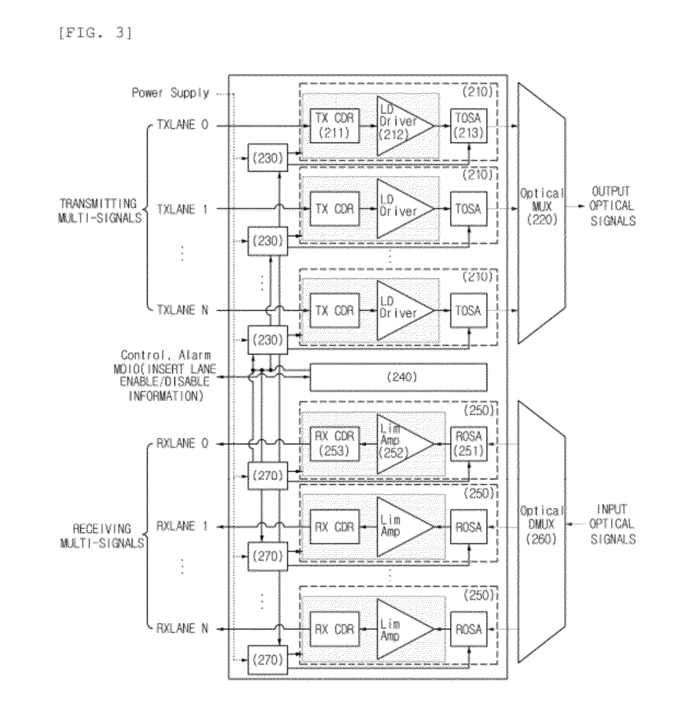

FIG. 3 is a second exemplified diagram illustrating the configuration of an optical transceiver module according to an exemplary embodiment of the present invention.

As shown in FIG. 3, the TX CDR and the LD driver configuring each transmitting unit which are physically coupled with each other are implemented in one chip to turn on/off the inputted power. That is, since N transmitting units are implemented in N lanes, N chips and one TOSA may be implemented. For example, the control means turns on/off the power applied to each of the N transmitting units, that is, turns on/off the power applied to one transmitting unit to turn on/off the power which is applied to each of the TX CDR, the LD driver, and the TOSA configuring one transmitting unit at the same time or in sequence.

Similarly, the limiting amplifier and the RX CDR configuring each receiving unit which are physically coupled with each other are also implemented in one chip to turn on/off the inputted power. For example, the control means turns on/off the power applied to each of the N receiving units, that is, turns on/off the power applied to one receiving unit to turn on/off the power which is applied to each of the ROSA, the limiting amplifier, and the RX CDR configuring one receiving unit at the same time or in sequence.

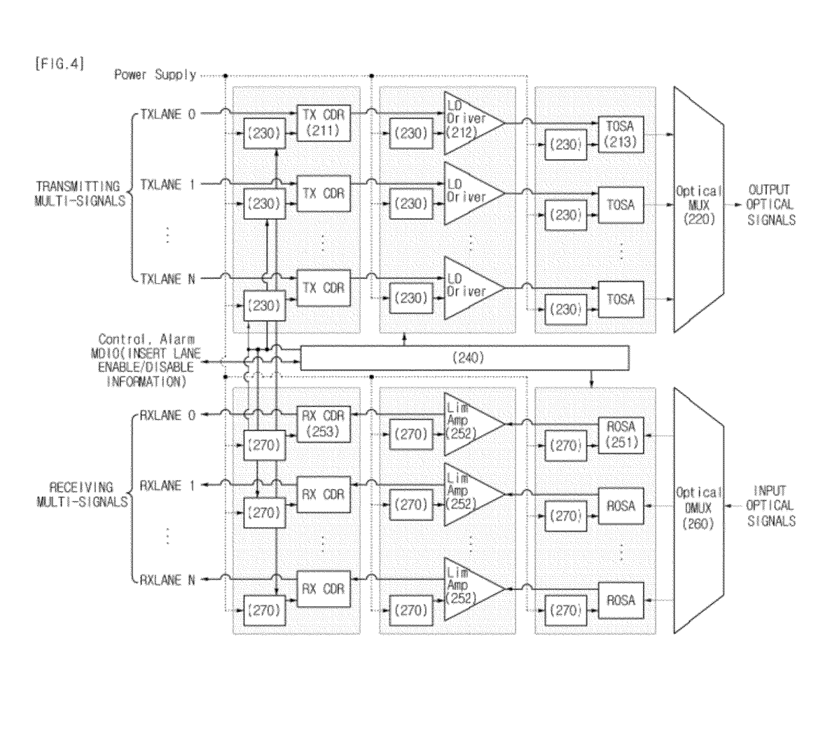

FIG. 4 is a third exemplified diagram illustrating the configuration of an optical transceiver module according to an exemplary embodiment of the present invention.

As shown in FIG. 4, the TX CDR, the LD driver, and the TOSA configuring each of the plurality of transmitting units which are coupled with each other for each function are implemented in one chip to turn on/off the inputted power. That is, a plurality of TX CDRs configuring each of the plurality of transmitting units are implemented in one TX CDR chip, a plurality of LD drivers are implemented in one LD driver chip, and a plurality of TOSAs are implemented in one TOSA chip. For example, each of the N transmitting units is implemented by the TX CDR, the LD driver, and the TOSA, which are implemented in three chips.

As described above, although the chips are implemented for each function, in order to turn on/off the power in each lane, the control for each constituent element is required. That is, the power of the plurality of TX CDRs configuring the TX CDR chip may be turned on/off. For example, the control means 240 may turn on/off the power which is applied to each of a first TX CDR in the TX CDR chip, a first LD driver in the LD driver chip, and a first TOSA in the TOSA chip at the same time or in sequence, in order to enable/disable the same first lane.

To this end, the first switching means is provided as many as the number of TX CDRs, LD drivers, and TOSAs to be connected to each of the TX CDRs, the LD drivers, and the TOSAs.

Similarly, the ROSA, the limiting amplifier and the RX CDR configuring each of the plurality of receiving units which are coupled with each other for each function are also implemented in one chip to turn on/off the inputted power. For example, the control means 240 may turn on/off the power, which is applied to each of the ROSA in the ROSA chip, the limiting amplifier in the limiting amplifier chip, and the RX CDR in the RX CDR chip on the first lane, at the same time or in sequence, in order to enable/disable the same first lane.

To this end, the second switching means is provided as many as the number of RX CDRs, limiting amplifiers, and ROSAs to be connected to each of the RX CDRs, the limiting amplifiers, and the ROSAs.

As described above, in the exemplary embodiment of the present invention, the transmitting unit or the receiving unit may be implemented in one chip by various methods. In addition, for example, the TX CDR and the LD driver may also be implemented in one chip at the same time. Further, in the case of the LD driver, since the power may be turned off by preventing an LD bias current or a modified current from flowing without the first switching means, the function of the first switching means for a LD driver may be replaced with the control means.

Meanwhile, the optical transceiver module according to the exemplary embodiment of the present invention receives the control signal including enable/disable information in each lane from the system board to turn on/off the power in each lane according to the received control signal.

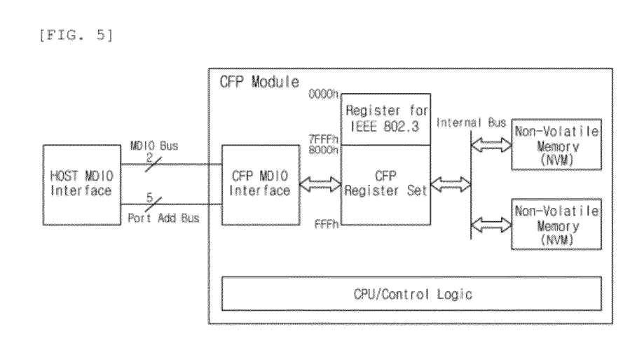

FIG. 5 is an exemplified diagram for describing a principle interlocked with a system board according to an exemplary embodiment of the present invention.

As shown in FIG. 5, the optical transceiver module according to the exemplary embodiment of the present invention may transceive the control signal from the system board through a management data input/output (MDIO) or an inter integrated circuit (I2C) interface. Herein, the MDIO and the I2C interface are physically configured by a data line and a clock line and used as a protocol for operation and management in many optical transceivers.

For example, as shown in FIG. 5, the MDIO interface is configured in a CFP multi-source agreement (MSA: industrial standard) frequently used in the optical transceivers for 40 G and 100 G Ethernet.

The control or monitoring of the optical transceiver module according to the exemplary embodiment of the present invention is performed through reading and writing operation of an IEEE 802.3 register and a CFP register and the registers are predetermined.

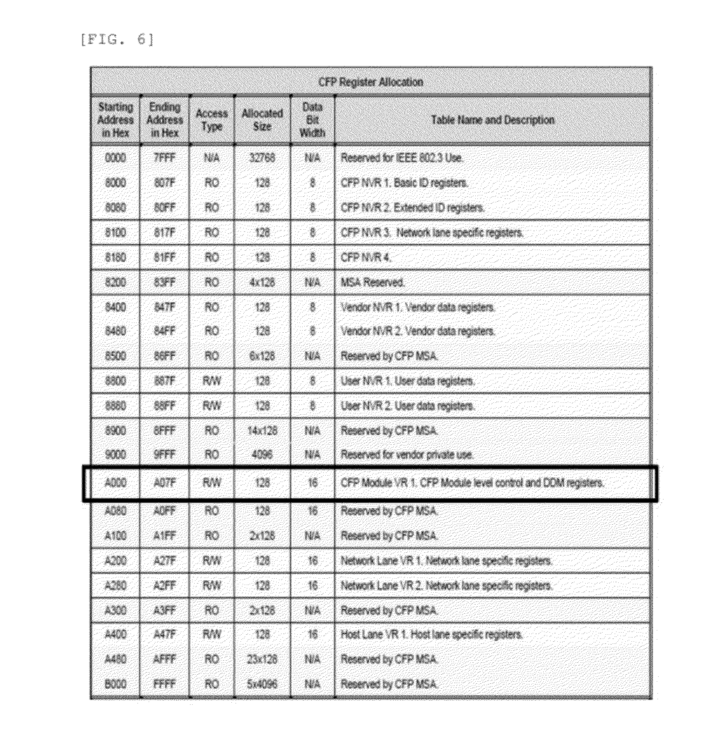

FIG. 6 is an exemplified diagram illustrating a predetermined register map according to an exemplary embodiment of the present invention.

As shown in FIG. 6, the optical transceiver module according to the exemplary embodiment of the present invention is operated and managed through communication channels, that is, the MDIO or I2C and an internal register set. The register for turning on/off the LD in each lane exists at an A013 address represented by a dotted line or the register enabling/disabling the operation of the switching means in each lane does not exist.

Therefore, in the exemplary embodiment of the present invention, the register enabling/disabling the operation of the switching means in each lane is allocated in a register in the optical transceiver and controlled through the register.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An optical transceiver module for controlling power in each lane, comprising:
a plurality of transmitting units formed in each lane in order to transmit signals to receive electric signals in each lane, convert the received electric signals into optical signals, and transmit the converted optical signals, respectively;
a first switching means turning on/off power supplied to each of the plurality of transmitting units in each lane;
a plurality of receiving units formed in each lane to receive optical signals in each lane, convert the received optical signals into electric signals, and output the converted electric signals, respectively;
a second switching means turning on/off power supplied to each of the plurality of receiving units in each lane; and
a control means controlling switching operations of the first switching means and the second switching means.

2. The optical transceiver module for controlling power in each lane of claim 1, wherein the transmitting unit includes:
a clock and data recovery (TX CDR) correcting distortion of the received electric signal;
a laser diode (LD) driver amplifying the corrected electric signal; and
a transmitter optical sub-assembly (TOSA) converting the amplified electric signal into the optical signal, wherein the TX CDR, the LD driver, and the TOSA are turned on/off at the same time or in sequence.

3. The optical transceiver module for controlling power in each lane of claim 2, wherein the first switching means is provided as many as the number of the plurality of transmitting units to be connected to each of the plurality of transmitting units.

4. The optical transceiver module for controlling power in each lane of claim 2, wherein the first switching means is provided as many as the number of the TX CDRs, the LD drivers, and the TOSAs to be connected to each of the TX CDRs, the LD drivers, and the TOSAs.

5. The optical transceiver module for controlling power in each lane of claim 1, wherein the receiving unit includes:
a receiver optical sub-assembly (ROSA) converting the received optical signal to an electric signal;
a limiting amplifier amplifying the converted electric signal; and
a clock and data recovery (RX CDR) correcting distortion of the amplified electric signal, wherein the RX CDR, the limiting amplifier, and the ROSA are turned on/off at the same time or in sequence.

6. The optical transceiver module for controlling power in each lane of claim 5, wherein the second switching means is provided as many as the number of the plurality of receiving units to be connected to each of the plurality of receiving units.

7. The optical transceiver module for controlling power in each lane of claim 5, wherein the second switching means is provided as many as the number of the RX CDRs, the limiting amplifiers, and the ROSAs to be connected to each of the RX CDRs, the limiting amplifiers, and the ROSAs.

8. The optical transceiver module for controlling power in each lane of claim 1, wherein each of the first switching means and the second switching means is a power switch or a load switch.

9. The optical transceiver module for controlling power in each lane of claim 1, wherein the control means receives a control signal including enable/disable information in each lane from a system board to control a switching operation of the first switching means or the second switching means according to the received control signal.

10. The optical transceiver module for controlling power in each lane of claim 9, wherein the control means receives the control signal including the enable/disable information in each lane from the system board through a management data input/output (MDIO) or inter integrated circuit (I2C) interface.

11. The optical transceiver module for controlling power in each lane of claim 1, wherein the control means controls the operations of the first switching means and the second switching means through a serial peripheral interface (SPI), an inter integrated circuit (I2C) interface, or voltage application.

12. An optical transceiver module for controlling power in each lane, comprising:
a plurality of transmitting units formed in each lane in order to transmit signals to receive electric signals in each lane, convert the received electric signals into optical signals, and transmit the converted optical signals, respectively;
a first switching means turning on/off power supplied to each of the plurality of transmitting units in each lane; and
a control means controlling a switching operation of the first switching means.

13. The optical transceiver module for controlling power in each lane of claim 12, wherein the transmitting unit includes:
a clock and data recovery (TX CDR) correcting distortion of the received electric signal;
a laser diode (LD) driver amplifying the corrected electric signal; and
a transmitter optical sub-assembly (TOSA) converting the amplified electric signal into the optical signal, wherein the TX CDR, the LD driver, and the TOSA are turned on/off at the same time or in sequence.

14. The optical transceiver module for controlling power in each lane of claim 13, wherein in the transmitting unit, the TX CDR, the LD driver, and the TOSA are implemented in one chip to be turned on/off at the same time or in sequence.

15. An optical transceiver module for controlling power in each lane, comprising:
a plurality of receiving units formed in each lane in order to transmit a signal to receive optical signals in each lane, convert the received optical signals into electric signals, and output the converted electric signals, respectively;
a second switching means turning on/off power supplied to each of the plurality of receiving units in each lane; and
a control means controlling switching operations of the first switching means and the second switching means.

16. The optical transceiver module for controlling power in each lane of claim 15, wherein the receiving unit includes:
a receiver optical sub-assembly (ROSA) converting the received optical signal to an electric signal;
a limiting amplifier amplifying the converted electric signal; and
a clock and data recovery (RX CDR) correcting distortion of the amplified electric signal, wherein the RX CDR, the limiting amplifier, and the ROSA are turned on/off at the same time or in sequence.

17. The optical transceiver module for controlling power in each lane of claim 16, wherein in the receiving unit, the RX CDR, the limiting amplifier, and the ROSA are implemented in one chip to be turned on/off at the same time or in sequence.
